(19) United States
(12) Patent Application Publication
(10) Pub. No.: US 2022/0159560 A1
(43) Pub. Date: May 19, 2022

(54) SYSTEM, WIRELESS TERMINAL, AND METHOD THEREFOR

(71) Applicant: NEC Corporation, Minato-ku, Tokyo (JP)

(72) Inventors: Masaru YANAI, Tokyo (JP); Hiroaki AMINAKA, Tokyo (JP)

(73) Assignee: NEC Corporation, Minato-ku, Tokyo (JP)

(21) Appl. No.: 17/439,505

(22) PCT Filed: Dec. 20, 2019
(86) PCT No.: PCT/JP2019/050097

§ 371 Date: Sep. 15, 2021

(30) Foreign Application Priority Data
Mar. 22, 2019 (JP) 2019-055094

(51) Int. Cl. H04W 48/18; H04W 48/16; H04W 4/90

(52) U.S. Cl. CPC H04W 48/18; H04W 4/90; H04W 48/16

(57) ABSTRACT

One or more servers (11) communicate with one or more applications running on each of a plurality of wireless terminals (2) via a first or second cellular communication network (3, 4). The one more servers (11) determine and send to each wireless terminal (2) a network selection parameter used by each wireless terminal to select from the first and second cellular communication networks (3, 4) a cellular communication network used to communicate with the one more servers (11), based on one or any combination of an application priority associated with each application, a device priority associated with each wireless terminal (2), and an organization priority associated with an organization to which the plurality of wireless terminals (2) belong. This, for example, allows priority handling regarding a public safety service to be reflected in a selection among a plurality of cellular communication networks.

### TECHNICAL FIELD

The present disclosure relates to wireless communication, and in particular to selection among cellular communication networks.

### BACKGROUND ART

It is being considered to use a Long Term Evolution (LTE) network for a public safety network. The public safety network is a wireless communication network used for emergency services such as police, firefighting, and medical emergency, as well as highly public applications such as local governments and electric power, gas, and water utilities. The LTE system for public safety networks is called Public Safety LTE (PS-LTE). The Third Generation Partnership Project (3GPP) defines Mission Critical Push-to-Talk (MCPTT), which is one of the main features of PS-LTE (see, for example, Non-Patent Literature 1). The MCPTT architecture uses the aspects of the Group Communication System for LTE (GCSE_LTE) architecture, and also the aspects of the IP Multimedia Subsystem (IMS) architecture and the Proximity-based Services (ProSe) architecture. The GCSE_LTE enables group communication (see, for example, Non-Patent Literature 2).

It can be said that the PS-LTE network or system is a collection of hardware entities that provide applications, services, capabilities, and functions required to provide public safety services on an LTE network. The PS-LTE network or system may be a public LTE network (Public Land Mobile Network (PLMN)), a private LTE network, or a combination thereof.

The PS-LTE provides public safety services such as a PTT service. The PTT service is a Push To Talk communication service supporting applications for Mission Critical Organizations and for other businesses and organizations (e.g., public utilities and railways) with fast setup times, high availability, and reliability and priority handling. The public safety organizations include, for example, local police departments and local fire departments.

A user (e.g., PTT user) who uses a public safety service (e.g., PTT service) uses a wireless terminal or device (e.g., PS User Equipment (UE)) which has the capability to participate in the public safety service. Such devices (e.g., PS UE) allow users to participate in public safety services. Public safety service users include, for example, police officers and firefighters.

A public safety service provider is authorized to control parameters of the public safety service (e.g., PTT service) provided to a public safety organization. These parameters include, for example, user and group definition, user priorities, group membership/priorities/hierarchies, and security and privacy controls. A public safety service provider can also be referred to as a public safety service administrator.

The business relationships of public safety service users, public safety organizations, and public safety service providers are as follows. A public safety service user belongs to a single public safety organization based on a user agreement. The public safety organization receives a public safety service from a public safety service provider based on an agreement. The public safety service user can have a user contract and service arrangement direct with the public safety service provider. The public safety organization and the public safety service provider can be part of the same organization. Further or alternatively, the public safety service provider and the PS-LTE network operator can be part of the same organization.

### CITATION LIST

### Non-Patent Literature

[Non-Patent Literature 1] 3GPP TS 23.179 V13.5.0 (2017-03), “3rd Generation Partnership Project; Technical Specification Group Services and System Aspects; Functional architecture and information flows to support mission critical communication services; Stage 2 (Release 13)”, March 2017
[Non-Patent Literature 2] 3GPP TS 23.468 V15.0.0 (2017-12), “3rd Generation Partnership Project; Technical Specification Group Services and System Aspects; Group Communication System Enablers for LTE (GCSE_LTE); Stage 2 (Release 15)”, December 2017

### SUMMARY OF INVENTION

### Technical Problem

The PS-LTE, which provides public safety services, may preferably be a private LTE network that is independent of public LTE networks. However, it may be difficult to ensure sufficient coverage with private LTE networks alone.

The inventors have studied using a public (or commercial) LTE infrastructure to complement the coverage of a public safety private LTE network and improve the connectivity of PS devices (i.e., UEs). In this case, the PS-LTE network or system uses both the private LTE network and the public (or commercial) LTE network and uses either or both of the two LTE networks for communication with each PS device (UE). In one scenario, the Mobile Virtual Network Operator (MVNO) approach may be used. Specifically, the PS-LTE network or system may rent part of a public LTE infrastructure of a Mobile Network Operator (MNO) and communicate with PS devices via the MNO's LTE network.

By the way, a PS-LTE network or system that provides a public safety service requires priority handling at various levels regarding business relationships. Specifically, for example, priority handling between multiple public safety organizations, between multiple public safety service users (or devices (UEs)), and between multiple public safety service applications are needed. The multiple public safety service applications include, for example, a PTT application, a push-to-video application, a voice call application, a video call application, and an instant messaging application.

In the PS-LTE system that can use multiple LTE networks to communicate with multiple UEs, it is preferable that the priority handling of the above-mentioned various layers is considered in selecting an LTE network to be used to communicate with each UE. One of the objects to be attained by embodiments disclosed herein is to provide apparatuses, methods, and programs that contribute to reflecting priority handling regarding a public safety service in a selection among a plurality of cellular communication networks. It should be noted that this object is merely one of the objects to be attained by the embodiments disclosed herein. Other objects or problems and novel features will be made apparent from the following description and the accompanying drawings.

### Solution to Problem

In a first aspect, a system includes at least one server. The at least one server is configured to communicate with one or more client applications running on each of a plurality of wireless terminals via a first cellular communication network or a second cellular communication network. In addition, the at least one server is configured to determine a network selection parameter used by each wireless terminal to select from the first and second cellular communication networks a cellular communication network used to communicate with the system, based on one or any combination of an application priority associated with each client application, a device priority associated with each wireless terminal, and an organization priority associated with an organization to which the plurality of wireless terminals belong. The at least one server is further configured to notify each wireless terminal of the network selection parameter.

In a second aspect, a method performed by a system, including at least one server, includes:
(a) communicating with one or more client applications running on each of a plurality of wireless terminals via a first cellular communication network or a second cellular communication network;
(b) determining a network selection parameter used by each wireless terminal to select from the first and second cellular communication networks a cellular communication network used to communicate with the system, based on one or any combination of an application priority associated with each client application, a device priority associated with each wireless terminal, and an organization priority associated with an organization to which the plurality of wireless terminals belong; and
(c) notifying each wireless terminal of the network selection parameter.

In a third aspect, a wireless terminal apparatus includes at least one memory and at least one processor coupled to the at least one memory. The at least one processor is configured to execute one or more client applications and communicate with one or more server side applications, running on a system including one or more servers, via a first cellular communication network or a second cellular communication network. In addition, the at least one processor is configured to receive from the system a network selection parameter determined based on one or any combination of an application priority associated with each client application, a device priority associated with the wireless terminal apparatus, and an organization priority associated with an organization to which a plurality of wireless terminals including the wireless terminal apparatus belong. The at least one processor is further configured to select, based on the network selection parameter, from the first and second cellular communication networks a cellular communication network used to communicate with the one or more server side applications.

In a fourth aspect, a method performed by a wireless terminal apparatus includes:
(a) executing one or more client applications and communicating with one or more server side applications, running on a system including one or more servers, via a first cellular communication network or a second cellular communication network;
(b) receiving from the system a network selection parameter determined based on one or any combination of an application priority associated with each client application, a device priority associated with the wireless terminal apparatus, and an organization priority associated with an organization to which a plurality of wireless terminals including the wireless terminal apparatus belong; and
(c) selecting, based on the network selection parameter, from the first and second cellular communication networks a cellular communication network used to communicate with the one or more server side applications.

In a fifth aspect, a program includes instructions (software codes) that, when loaded into a computer, cause the computer to perform the method according to the above-described second or fourth aspect.

### Advantageous Effects of Invention

According to the above-described aspects, it is possible to provide apparatuses, methods, and programs that contribute to reflecting priority handling regarding a public safety service in a selection among a plurality of cellular communication networks.

### BRIEF DESCRIPTION OF DRAWINGS

FIG. 1 is a block diagram showing a configuration example of a cellular communication network according to embodiments;

FIG. 2 is a block diagram showing a configuration example of a network platform according to embodiments;

FIG. 3 is a flowchart showing an example of operation of a network platform according to a first embodiment;

FIG. 4 is a flowchart showing an example of operation of a wireless terminal according to the first embodiment;

FIG. 5 is a flowchart showing an example of operation of a network platform according to a second embodiment;

FIG. 6 is a flowchart showing an example of operation of a network platform according to a third embodiment;

FIG. 7 is a flowchart showing an example of operation of a network platform according to a fourth embodiment;

FIG. 8 is a block diagram showing a configuration example of a server according to embodiments; and

FIG. 9 is a block diagram showing a configuration example of a wireless terminal according to embodiments.

### DESCRIPTION OF EMBODIMENTS

Specific embodiments will be described hereinafter in detail with reference to the drawings. The same or corresponding elements are denoted by the same symbols throughout the drawings, and duplicated explanations are omitted as necessary for the sake of clarity.

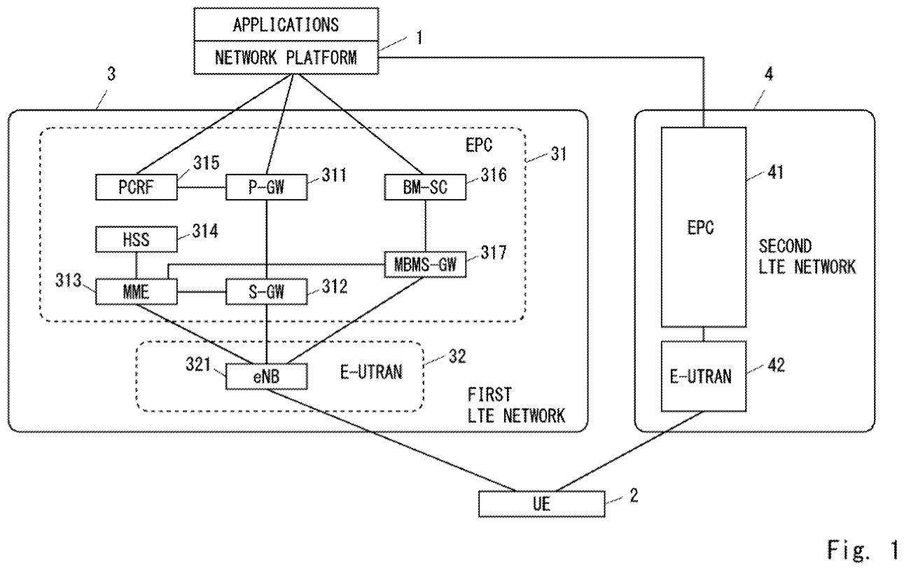

FIG. 1 shows a configuration example of a PS-LTE network or system according to embodiments including the present embodiment. The PS-LTE network or system provides one or more public safety services (e.g., a PTT service). In the example of FIG. 1, the PS-LTE network includes a network platform 1, a first LTE network 3, and a second LTE network. The network platform 1 communicates with one or more applications (e.g., a PTT client application and a Session Initiation Protocol (SIP) client application) running on each of a plurality of wireless terminals (UEs) 2 through one or more communication paths provided by the LTE network 3 or 4. In other words, the network platform 1 includes a plurality of functional entities in the application domain and communicates with the UEs 2 on the application layer (or application service layer). The UEs 2 are also referred to as public safety devices.

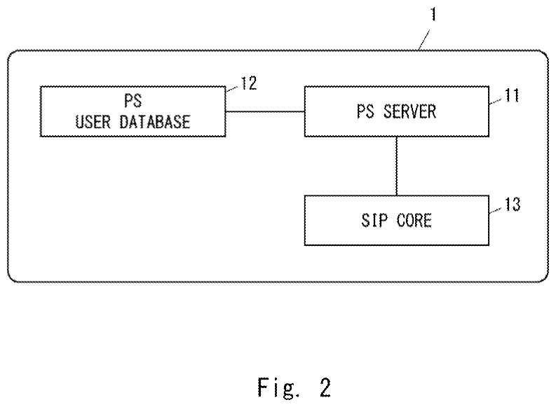

The network platform 1 includes one or more servers. Each server included in the network platform 1 may be one or more computers. For example, as shown in FIG. 2, the network platform 1 may include a PS server 11, a PS user database 12, and a SIP core 13. The PS server 11 provides centralized support for a PS service (e.g., PTT service, push-to-video service). More specifically, the PS server 11 is responsible for, for example, PS user authentication, keeping tracking of the locations of the UEs 2 (PS UEs), and requesting the allocation of resources in the cellular communication network to the UEs 2. The PS server 11 may include the functions of a GCS application server (AS). The PS user database 12 stores information of PS user profiles. The PS user profile are determined by a public safety organization, a public safety service provider, and potentially a public safety service user. The SIP core 13 is in charge of SIP registration, establishes a SIP signaling bearer, and sends and receives SIP signaling messages to and from each UE 2 (SIP client on each UE 2). The PS user database 12 may be a device outside the network platform 1.

Further or alternatively, the network platform 1 may include other servers. The network platform 1 may include, for example, but not limited to, a GCS application server (AS) and/or a SIP database. The GCS AS uses an EPS bearer service or an MBMS bearer service, performing transfer or delivery of application signaling and application data to a group of UEs. The SIP database stores SIP subscriber information (SIP subscriptions) and authentication information that are required by the SIP core 13.

The LTE network 3 includes a core network (i.e., Evolved Packet Core (EPC)) 31 and a radio access network (i.e., Evolved Universal Terrestrial Radio Access Network (E-UTRAN)) 32. The EPC 31 includes a plurality of nodes, which include a plurality of control plane nodes and a plurality of user plane (or data plane) nodes. One or more nodes in the EPC 31 may have both control plane and user plane functions. For example, as shown in FIG. 1, the EPC 31 may include a Packet Data Network Gateway (P-GW) 311, a Serving Gateway (S-GW) 312, a Mobility Management Entity 313, a Home Subscriber Server (HSS) 314, a Policy and Charging Rules Function (PCRF) 315, a Broadcast Multicast Service Center (BM-SC) 316, and an MBMS Gateway (MBMS GW) 317. The E-UTRAN 32 includes a base station (eNodeB (eNB)) 321. Of course, although not explicitly shown in FIG. 1, the EPC 31 may include a plurality of S-GWs 312, and the E-UTRAN 32 may include a plurality of eNBs 321.

The second LTE network 4 includes an EPC 41 and an E-UTRAN 42. Although omitted in FIG. 1, the EPC 41 may include core network nodes similar to those in the EPC 31, and the E-UTRAN 42 may include RAN nodes similar to those in the E-UTRAN 32.

In some implementations, the first LTE network 3 may be a private LTE network specifically constructed for PS-LTE, while the second LTE network 4 may be a public or commercial LTE network. In this case, as described above, this may be an MVNO network that rents MNO infrastructure or resources.

In this embodiment, each UE 2 may use a plurality of communication modems and a plurality of Universal Integrated Circuit Cards (UICCs) (or Subscriber Identity Modules (SIM)) for the first LTE network 3 and the second LTE network 4 to connect simultaneously to the two LTE networks 3 and 4. Alternatively, each UE 2 may be configured to selectively connect to either of the two LTE networks 3 and 4.

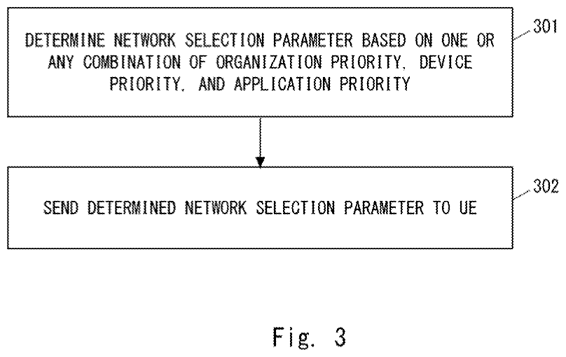

FIG. 3 shows an example of an operation of the network platform 1 according to the present embodiment. The operation shown in FIG. 3 may be performed by a single server (e.g., the PS server 11) in the network platform 1 or by a plurality of servers (e.g., the PS server 11 and the PS user database 12).

In step 301, based on one or any combination of an organization priority, a device priority, and an application priority, the network platform 1 determines a network selection parameter used by each UE 2 to select from the cellular networks 3 and 4 an LTE network for communicating with the network platform 1. The network selection parameter may be determined per UE 2 or per group of UEs.

The organization priority is a priority (or priority level) of each of a plurality of public safety organizations (e.g., local police departments and multiple local fire departments) that use a public safety service provided by the PS-LTE network. The organization priority is used for priority handling among these multiple public safety organizations.

The device priority is a priority (or priority level) of each UE 2 used by each user belonging to a single public safety organization. The device priority is used for priority handling among multiple UEs 2.

The application priority is a priority (or priority level) of each public safety service application executed on each UE 2 (or of each application service provided to each UE 2). The application priority is used for priority handling among multiple applications. The multiple public safety service applications include, for example, any combination of a PTT application, a push-to-video application, a voice call application, a video call application, and an instant messaging application.

Preferably, the network platform 1 may determine the network selection parameter using at least two of the organization priority, the device priority, and the application priority. In this case, the multiple priorities considered may be weighted by different factors from each other.

In some implementations, the network platform 1 may acquire the organization priority, the device priority, and the application priority from the server (e.g., PS user database 12) that manages information on public safety service users.

Returning to FIG. 3, in step 302, the network platform 1 sends the network selection parameter determined in step 301 to one or more UEs 2.

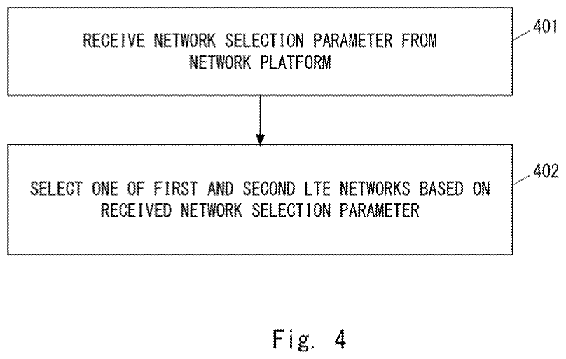

FIG. 4 shows an example of an operation of the UE 2 according to the present embodiment. In step 401, the UE 2 receives a network selection parameter from the network platform 1. In step 402, the UE 2 selects one of the first and second LTE networks 3 and 4 to communicate with the system 1 based on the received network selection parameter.

In some implementations, when the UE 2 has been attached to both the first and second LTE networks 3 and 4 (i.e., EMM-REGISTERED) and is in an idle mode (i.e., RRC_IDLE), it may perform the network selection to transition to a connected mode (i.e., RRC_CONNECTD). Further or alternatively, when the UE 2 has not yet been attached to either of the first and second LTE networks 3 and 4 (i.e., EMM-DEREGISTERED), it may perform the network selection to determine a network to attach. Further or alternatively, when the UE 2 is in a connected mode (i.e., RRC_CONNECTD) in the first LTE network 3, it may perform the network selection to move to the second LTE network 4.

In one example, the network selection parameter may be an offset value that when the UE 2 compares a radio quality of the first LTE network 3 with a radio quality of the second LTE network 4, is added to (or subtracted from) one of these two radio qualities. Alternatively, the network selection parameter may include two offset values to be added to (or subtracted from) these two radio qualities, respectively. The radio quality of the LTE network may be one or both of a cell reception level (i.e., signal strength) (e.g., Reference Signal Received Power (RSRP)) measured by the UE 2 and a cell quality level (i.e., signal quality) (e.g., Reference Signal Received Quality (RSRQ)) measured by the UE 2.

According to the above-mentioned operations, the network platform 1 allows one or any combination of the organization priority, the device priority, and the application priority, which are related to the public safety service, to be reflected in the LTE network selection performed by the UE 2. In other words, the network platform 1 can control the LTE network selection performed by the UE 2 based on one or any combination of the organization priority, the device priority, and the application priority, which are related to the public safety service.

### Second Embodiment

The present embodiment provides a modified example of the operations of the network platform 1 described in the first embodiment. A configuration example of a PS-LTE network according to the present embodiment is the same as that shown in FIGS. 1 and 2. In this embodiment, the network platform 1 is configured to dynamically change at least one of an application priority, a device priority, and an organization priority depending on a load of the LTE network 3 or 4, thereby updating a network selection parameter used by the UE 2.

The load of the first LTE network 3 may be a load of the E-UTRAN 32 or a load of the EPC 31. The load of the E-UTRAN 32 may be a load of the eNB 321 or a load on any cell provided by the eNB 321. The load of the E-UTRAN 32 may be related to the number of UEs of the eNB 321 or the cell, the number of connections (e.g., Radio Resource Control (RRC) connections) of the eNB 321 or the cell, or a radio resource usage amount (or rate) in the eNB 321 or the cell. The load of the EPC 31 may be a load of any EPC node (e.g., MME 313, P-GW311). The load of the EPC 31 may be related to the number of UEs associated with the EPC node, the number of connections (e.g., PDN connections) associated with the EPC node, or the amount of user traffic associated with the EPC node. The load of the second LTE network 4 may be defined in the same manner as the load of the first LTE network 3.

The network platform 1 may acquire the load of the LTE network 3 (or 4) from, for example, a monitoring system (e.g., an Element Management System (EMS)) of the LTE network 3 (or 4).

In one example, the network platform 1 may update at least one of the application priority, the device priority, and the organization priority, so as to reduce a load of a heavily loaded cell, eNB, or EPC node. More specifically, for example, when the EPC node in the first LTE network 3 is under heavy load, the network platform 1 may lower the priority of an application (e.g., video call application) that require a relatively high data rate and determine the network selection parameter based on the updated application priority. This may cause the network platform 1 to prompt the UEs 2 to select the second LTE network 4 for transmission of IP packet flows regarding applications that require relatively high data rates.

Additionally or alternatively, when a cell of the first LTE network 3 is under heavy load, the network platform 1 may lower the device priority of UEs 2 located in this cell and determine the network selection parameter based on the updated application priority. This may cause the network platform 1 to prompt the UEs 2 belonging to the heavy loaded cell to select the second LTE network 4.

Additionally or alternatively, when an eNB 321 of the first LTE network 3 is under heavy load, the network platform 1 may adjust the organization priority of one or more public safety organizations utilizing this eNB 321 and determine the network selection parameter based on the adjusted organization priority. This may cause the network platform 1 to prompt the UEs 2 connected to the heavy loaded eNB 321 to select the second LTE network 4.

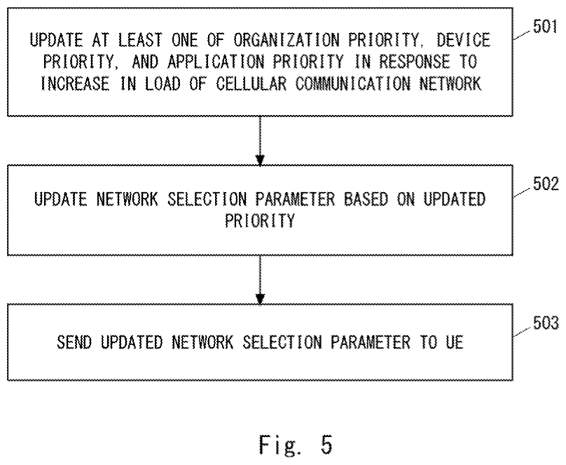

FIG. 5 shows an example of an operation of the network platform 1 according to the present embodiment. The operation shown in FIG. 5 may be performed by a single server (e.g., the PS server 11) in the network platform 1 or by a plurality of servers (e.g., the PS server 11 and the PS user database 12).

In step 501, the network platform 1 updates at least one of the organization priority, the device priority, and the application priority in response to an increase in a load of the LTE network 3. In step 502, the network platform 1 updates a network selection parameter(s) for one or more UEs 2 based on the updated priority(ies). In step 503, the network platform 1 sends the network selection parameter(s) determined (or updated) in step 502 to the one or more UEs 2.

According to the above operation, the network platform 1 can dynamically change at least one of the organization priority, the device priority, and the application priority according to a load of the LTE network 3 or 4, thereby dynamically updating a network selection parameter used by the UE 2.

### Third Embodiment

The present embodiment provides a modified example of the operation of the network platform 1 described in the first embodiment. A configuration example of a PS-LTE network according to the present embodiment is the same as that shown in FIGS. 1 and 2.

In this embodiment, the network platform 1 is configured to dynamically change at least one of an application priority, a device priority, and an organization priority in response to an occurrence of a disaster event, thereby updating a network selection parameter used by the UE 2. The disaster event may be, for example, an earthquake, a volcanic eruption, a flood, a tornado, a tsunami, or a large fire.

In some implementations, the network platform 1 may receive a message indicating an occurrence of a disaster event from another server or from any application.

In one example, the network platform 1 may adjust the organization priority of one or more public safety organizations so that the organization priority of a particular public safety organization associated with the disaster event that has occurred is relatively high, and determine the network selection parameter based on the adjusted organization priority. This may cause the network platform 1 to prompt the UEs 2 of users belonging to the public safety organization associated with the occurred disaster event to select the first LTE network 3. Meanwhile, the network platform 1 may prompt the UEs 2 of users, belonging to public safety organizations not associated with the occurred disaster event, to select the second LTE network 4.

Additionally or alternatively, the network platform 1 may adjust the application priority of one or more applications so that the application priority of a particular application associated with the disaster event that occurred is relatively high, and then determine the network selection parameter based on the adjusted application priority. This may cause the network platform 1 to prompt the UEs 2 to select the first LTE network 3 for communication of the application associated with the disaster event. Meanwhile, the network platform 1 may prompt the UEs 2 to select the second LTE network 4 for communication of applications not associated with the disaster event.

Additionally or alternatively, the network platform 1 may adjust the device priority of one or more UEs 2 so that the device priority of UEs 2 located in the area of the disaster event that occurred is relatively high, and then determine the network selection parameter based on the adjusted device priority. This may cause the network platform 1 to prompt the UEs 2 located in the area of the disaster event to select the first LTE network 3. Meanwhile, the network platform 1 may prompt the UEs 2 not being located in the area of the disaster event to select the second LTE network 4.

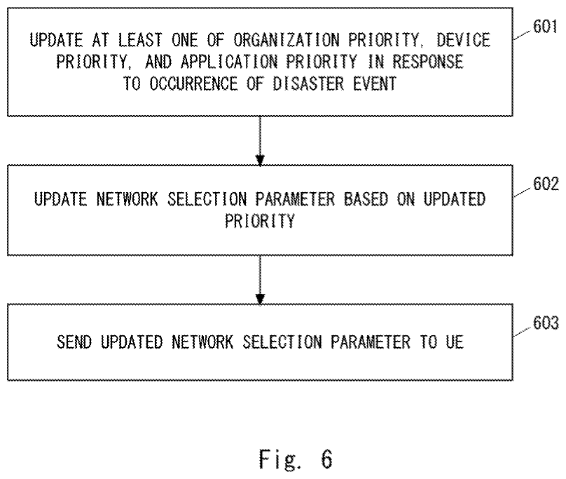

FIG. 6 shows an example of an operation of the network platform 1 according to the present embodiment. The operation shown in FIG. 6 may be performed by a single server (e.g., the PS server 11) in the network platform 1 or by a plurality of servers (e.g., the PS server 11 and the PS user database 12).

In step 601, the network platform 1 updates at least one of the organization priority, the device priority, and the application priority in response to an occurrence of a disaster event. In step 602, the network platform 1 updates a network selection parameter(s) of one or more UEs 2, based on the updated priority. In step 603, the network platform 1 sends the network selection parameter(s) determined (or updated) in step 602 to the one or more UEs 2.

According to the above operation, the network platform 1 can dynamically change at least one of the organization priority, the device priority, and the application priority in response to an occurrence of a disaster event, thereby dynamically changing a network selection parameter used by the UE 2.

### Fourth Embodiment

The present embodiment provides a modified example of the operations of the network platform 1 described in the first to third embodiments. A configuration example of a PS-LTE network according to the present embodiment is the same as that shown in FIGS. 1 and 2.

In this embodiment, the network platform 1 may change at least one of an application priority, a device priority, and an organization priority, in response to an occurrence of an event that is different from events regarding loads of the LTE network 3 and 4 and from disaster events.

Additionally or alternatively, the network platform 1 may change a rule or calculation formula for deriving a network selection parameter (e.g., an offset value for radio quality) from one or any combination of the application priority, the device priority, and the organization priority, in response to an occurrence of a predetermined event. The predetermined event may be an event related to a load of the LTE network 3 or 4 (e.g., load increase or decrease), a disaster event, or another event different from these.

Further or alternatively, the network platform 1 may exclude at least one of the application priority, the device priority, and the organization priority from the rule or calculation formula for deriving the network selection parameter, in response to the occurrence of a predetermined event.

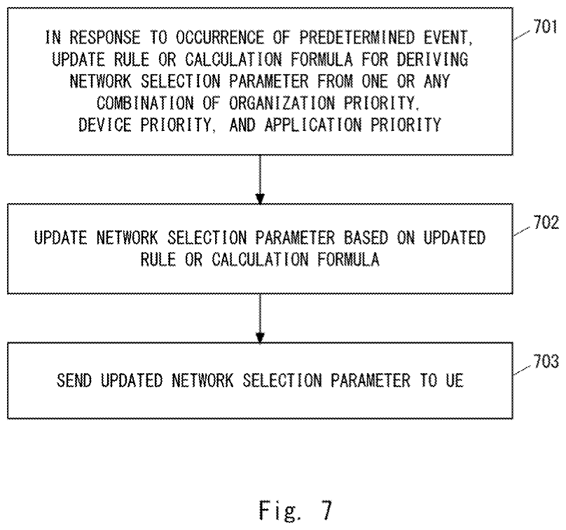

FIG. 7 shows an example of an operation of the network platform 1 according to the present embodiment. The operation shown in FIG. 7 may be performed by a single server (e.g., the PS server 11) in the network platform 1 or by a plurality of servers (e.g., the PS server 11 and the PS user database 12).

In step 701, in response to an occurrence of a predetermined event, the network platform 1 updates a rule or calculation formula for deriving a network selection parameter from one or any combination of the application priority, the device priority, and the organization priority. In step 702, the network platform 1 updates a network selection parameter(s) regarding one or more UEs 2 based on the updated rule or formula. In step 703, the network platform 1 sends the network selection parameter(s) determined (or updated) in step 702 to the one or more UEs 2.

According to the above operation, the network platform 1 can change the rule or calculation formula for deriving a network selection parameter in response to the occurrence of a predetermined event, thereby dynamically changing the network selection parameter used by the UE 2.

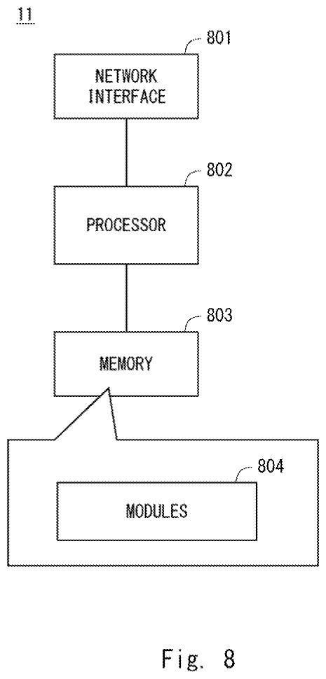

The following provides configuration examples of the one or more servers in the network platform 1, and the UE 2 according to the above-described embodiments. FIG. 8 is a block diagram showing a configuration example of the PS server 11. The configurations of the other servers in the network platform 1 may be similar to that shown in FIG. 8. Referring to FIG. 8, the PS server 11 includes a network interface 801, a processor 802, and a memory 803. The network interface 801 is used to communicate with other servers (e.g., PS user database 12 and the SIP core 13) in the network platform 1, nodes (e.g., the P-GW 311, the PCRF 315, and the BM-SC 316) in the EPC 31 and the EPC 41, and other nodes. The network interface 801 may include, for example, a network interface card (NIC) conforming to the IEEE 802.3 series.

The processor 802 loads and executes software (computer programs) from the memory 803, thereby performing the processing of the PS server 11 described in the above embodiments. The processor 802 may be, for example, a microprocessor, a Micro Processing Unit (MPU), or a Central Processing Unit (CPU). The processor 802 may include a plurality of processors.

The memory 803 is composed of a volatile memory and a nonvolatile memory. The volatile memory is, for example, a Static Random-Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 803 may include a storage located apart from the processor 802. In this case, the processor 802 may access the memory 803 via the network interface 801 or an I/O interface (not illustrated).

The memory 803 may store one or more software modules (computer programs) 804 including instructions and data to perform the processing of the PS server 11 described in the above embodiments. In some implementations, the processor 802 may be configured to load the one or more software modules 804 from the memory 803 and execute the loaded software modules, thereby performing the processing of the PS server 11 described in the above embodiments.

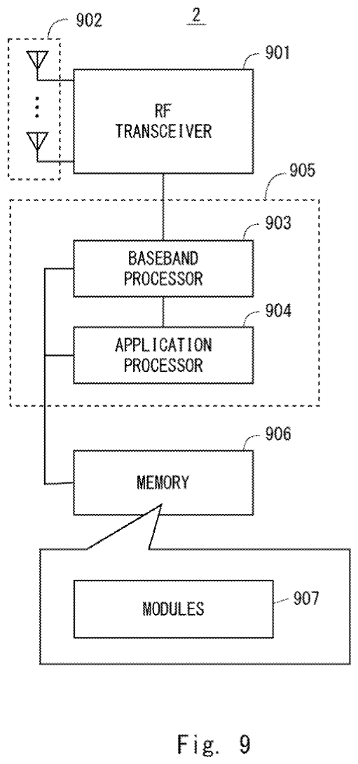

FIG. 9 is a block diagram showing a configuration example of the UE 2. A Radio Frequency (RF) transceiver 901 performs analog RF signal processing to communicate with the gNB 321. The RF transceiver 901 may include a plurality of transceivers. The analog RF signal processing performed by the RF transceiver 901 includes frequency up-conversion, frequency down-conversion, and amplification. The RF transceiver 901 is coupled to an antenna array 902 and a baseband processor 903. The RF transceiver 901 receives modulated symbol data (or OFDM symbol data) from the baseband processor 903, generates a transmission RF signal, and supplies the transmission RF signal to the antenna array 902. The RF transceiver 901 also generates a baseband received signal based on a received RF signal received by the antenna array 902 and supplies the baseband received signal to the baseband processor 903. The RF transceiver 901 may include an analog beamformer circuit for beam forming. The analog beamformer circuit includes, for example, a plurality of phase shifters and a plurality of power amplifiers.

The baseband processor 903 performs digital baseband signal processing (i.e., data-plane processing) and control-plane processing for radio communication. The digital baseband signal processing includes, for example, (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). Meanwhile, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

The digital baseband signal processing by the baseband processor 903 may include, for example, signal processing of a Packet Data Convergence Protocol (PDCP) layer, a Radio Link Control (RLC) layer, a Medium Access Control (MAC) layer, and a Physical (PHY) layer. The control-plane processing performed by the baseband processor 903 may include processing of Non-Access Stratum (NAS) protocols, Radio Resource Control (RRC) protocols, and MAC Control Elements (CEs).

The baseband processor 903 may perform MIMO encoding and pre-coding for beam forming.

The baseband processor 903 may include a modem processor (e.g., Digital Signal Processor (DSP)) that performs the digital baseband signal processing and a protocol stack processor (e.g., a CPU or an MPU) that performs the control-plane processing. In this case, the protocol stack processor, which performs the control-plane processing, may be integrated with an application processor 904 described in the following.

The application processor 904 is also referred to as a CPU, an MPU, a microprocessor, or a processor core. The application processor 904 may include a plurality of processors (processor cores). The application processor 904 loads a system software program (Operating System (OS)) and various application programs (e.g., a call application, a WEB browser, a mailer, a camera operation application, and a music player application) from a memory 906 or from another memory (not illustrated) and executes these programs, thereby providing various functions of the UE 2.

In some implementations, as represented by a dashed line (905) in FIG. 9, the baseband processor 903 and the application processor 904 may be integrated on a single chip. In other words, the baseband processor 903 and the application processor 904 may be implemented in a single System on Chip (SoC) device 905. An SoC device may be referred to as a Large-Scale Integration (LSI) or a chipset.

The memory 906 is a volatile memory, a non-volatile memory, or a combination thereof. The memory 906 may include a plurality of memory devices that are physically independent from each other. The volatile memory is, for example, an SRAM, a DRAM, or a combination thereof. The non-volatile memory is, for example, an MROM, an EEPROM, a flash memory, a hard disc drive, or any combination thereof. The memory 906 may include, for example, an external memory device that can be accessed from the baseband processor 903, the application processor 904, and the SoC 905. The memory 906 may include an internal memory device that is integrated in the baseband processor 903, the application processor 904, or the SoC 905. The memory 906 may also include a memory in a Universal Integrated Circuit Card (UICC).

The memory 906 may store one or more software modules (computer programs) 907 including instructions and data to perform the processing by the UE 2 described in the above embodiments. In some implementations, the baseband processor 903 or the application processor 904 may load these software modules 907 from the memory 906 and execute the loaded software modules, thereby performing the processing of the UE 2 described in the above embodiments with reference to the drawings.

The control-plane processing and operations performed by the UE 2 described in the above embodiments can be achieved by elements other than the RF transceiver 901 and the antenna array 902, i.e., achieved by the memory 906, which stores the software modules 907, and one or both of the baseband processor 903 and the application processor 904.

As described above with reference to FIGS. 8 and 9, each of the processors that the server (e.g., the PS server 11) and the UE 2 according to the above embodiments include executes one or more programs including instructions for causing a computer to execute an algorithm described with reference to the drawings. These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the programs to a computer via a wired communication line (e.g., electric wires, and optical fibers) or a wireless communication line.

### Other Embodiments

Each of the above-described embodiments may be used individually or two or more embodiments may be appropriately combined with one another.

The above-described embodiments have been described mainly for LTE systems (i.e., PS-LTE systems) that provide one or more public safety services. However, these embodiments may be applied to public safety systems that use cellular communication networks other than LTE.

Furthermore, the above-described embodiment may be applied to a public safety system using a plurality of cellular communication networks of different types. In one example, one of the cellular communication networks may be an LTE network and another one may be a non-LTE cellular communication network.

The above-described embodiments are merely examples of applications of the technical ideas obtained by the inventors. These technical ideas are not limited to the above-described embodiments and various modifications can be made thereto.

This application is based upon and claims the benefit of priority from Japanese Patent Application No. 2019-055094, filed on Mar. 22, 2019, the disclosure of which is incorporated herein in its entirety by reference.

### REFERENCE SIGNS LIST

1 Network Platform
2 UE
3 First LTE Network
4 Second LTE Network
11 PS Server
12 PS User Database
13 SIP Core
31 EPC
32 E-UTRAN
41 EPC
42 E-UTRAN
802 Processor
803 Memory
903 Baseband Processor
904 Application Processor
906 Memory

What is claimed is:

1. A system comprising:
at least one server configured to:
communicate with one or more client applications running on each of a plurality of wireless terminals via a first cellular communication network or a second cellular communication network;
determine a network selection parameter used by each wireless terminal to select from the first and second cellular communication networks a cellular communication network used to communicate with the system, based on one or any combination of an application priority associated with each client application, a device priority associated with each wireless terminal, and an organization priority associated with an organization to which the plurality of wireless terminals belong; and
notify each wireless terminal of the network selection parameter.

2. The system according to claim 1, wherein the network selection parameter is an offset value that when comparing a radio quality of the first cellular communication network with a radio quality of the second cellular communication network, is added to either of these two radio qualities.

3. The system according to claim 1, wherein the at least one server is configured to determine the network selection parameter by using at least two of the application priority, the device priority, and the organization priority.

4. The system according to claim 1, wherein the at least one server is configured to update at least one of the application priority, the device priority, and the organization priority, depending on a load of the first or second cellular communication network, thereby updating the network selection parameter.

5. The system according to claim 1, wherein the at least one server is configured to update a rule or a calculation formula for deriving the network selection from one or any combination of the application priority, the device priority, and the organization priority, depending on a load of the first or second cellular communication network, thereby updating the network selection parameter.

6. The system according to claim 1, wherein the at least one server is configured to update at least one of the application priority, the device priority, and the organization priority in response to an occurrence of a predetermined event, thereby updating the network selection parameter.

7. The system according to claim 1, wherein the at least one server is configured to update a rule or a calculation formula for deriving the network selection parameter from one or any combination of the application priority, the device priority, and the organization priority, in response to an occurrence of a predetermined event, thereby updating the network selection parameter.

8. The system according to claim 1, wherein the at least one server comprises one or any combination of a Push to Talk (PTT) server, a Session Initiation Protocol (SIP) server, and a Group Communication System Application Server (GCS AS).

9. The system according to claim 1, wherein
the first cellular communication network is a Public Safety Long Term Evolution (PS-LTE) network, and
the second cellular communication network is a commercial LTE network.

10. The system according to claim 9, wherein the at least one server is configured to update at least one of the application priority, the device priority, and the organization priority in response to an occurrence of a disaster event, thereby updating the network selection parameter.

11. The system according to claim 9, wherein the at least one server is configured to update a rule or a calculation formula for deriving the network selection parameter from one or any combination of the application priority, the device priority, and the organization priority, in response to an occurrence of a disaster event, thereby updating the network selection parameter.

12. The system according to claim 1, wherein
the first cellular communication network is a private Long Term Evolution (LTE) network, and
the second cellular communication network is a public LTE network.

13. A method performed by a system comprising at least one server, the method comprising:
communicating with one or more client applications running on each of a plurality of wireless terminals via a first cellular communication network or a second cellular communication network;
determining a network selection parameter used by each wireless terminal to select from the first and second cellular communication networks a cellular communication network used to communicate with the system, based on one or any combination of an application priority associated with each client application, a device priority associated with each wireless terminal, and an organization priority associated with an organization to which the plurality of wireless terminals belong; and
notifying each wireless terminal of the network selection parameter.

14. The method according to claim 13, wherein the network selection parameter is an offset value that when comparing a radio quality of the first cellular communication network with a radio quality of the second cellular communication network, is added to either of these two radio qualities.

15. (canceled)

16. a wireless terminal apparatus comprising:
at least one memory; and
at least one processor coupled to the at least one memory and configured to:
execute one or more client applications and communicate with one or more server side applications, running on a system including one or more servers, via a first cellular communication network or a second cellular communication network;
receive from the system a network selection parameter determined based on one or any combination of an application priority associated with each client application, a device priority associated with the wireless terminal apparatus, and an organization priority associated with an organization to which a plurality of wireless terminals including the wireless terminal apparatus belong; and
select, based on the network selection parameter, from the first and second cellular communication networks a cellular communication network used to communicate with the one or more server side applications.

17. The wireless terminal apparatus according to claim 16, wherein the network selection parameter is an offset value that when comparing a radio quality of the first cellular communication network with a radio quality of the second cellular communication network, is added to either of these two radio qualities.

18. The wireless terminal apparatus according to claim 16, wherein
the first cellular communication network is a Public Safety Long Term Evolution (PS-LTE) network, and
the second cellular communication network is a commercial LTE network.

19-22. (canceled)

23. The method according to claim 13, wherein said determining comprises determining the network selection parameter by using at least two of the application priority, the device priority, and the organization priority.

24. The method according to claim 13, further comprising updating at least one of the application priority, the device priority, and the organization priority, depending on a load of the first or second cellular communication network, thereby updating the network selection parameter.

25. The method according to claim 13, further comprising updating a rule or a calculation formula for deriving the network selection from one or any combination of the application priority, the device priority, and the organization priority, depending on a load of the first or second cellular communication network, thereby updating the network selection parameter.
